(19) United States
(12) Patent Application Publication
(10) Pub. No.: US 2025/0374857 A1
(43) Pub. Date: Dec. 11, 2025

(54) HARVESTING METHOD

(71) Applicant: PANASONIC INTELLECTUAL PROPERTY MANAGEMENT CO., LTD., Osaka (JP)

(72) Inventors: Hidekazu ARAKI, Osaka (JP); Ryou TOSHIMA, Nara (JP); Seiji NISHITANI, Kyoto (JP)

(73) Assignee: PANASONIC INTELLECTUAL PROPERTY MANAGEMENT CO., LTD., Osaka (JP)

(21) Appl. No.: 19/307,839

(22) Filed: Aug. 22, 2025

Related U.S. Application Data
(63) Continuation of application No. 17/323,963, filed on May 18, 2021.

(30) Foreign Application Priority Data
May 26, 2020 (JP) 2020-091383

(51) Int. Cl. A01D 46/253

(52) U.S. Cl. CPC A01D 46/253

(57) ABSTRACT

A harvesting method using a harvesting apparatus is provided. The harvesting apparatus includes a harvesting mechanism for harvesting a harvesting target that grows on a plant. The method includes: determining a vertical inclination, which is an inclination with respect to a vertical direction, of the harvesting target from an acquired image of the harvesting target; adjusting an angle of the harvesting mechanism with respect to the vertical inclination; bringing the harvesting mechanism closer to the harvesting target; and separating the harvesting target from the plant by the harvesting mechanism.

### CROSS REFERENCE TO RELATED APPLICATION

This is a Continuation of U.S. application Ser. No. 17/323,963, filed May 18, 2021, which claims priority to Japanese Patent Application No. 2020-091383, filed on May 26, 2020. The entire disclosure of each of the above-identified documents is incorporated herein by reference in its entirety.

### BACKGROUND

### 1. Technical Field

The present disclosure relates to a harvesting method for harvesting a target such as a fruit.

### 2. Description of the Related Art

It is desired to automate the harvesting work of agricultural products. In the related art, as an apparatus for performing automatic harvesting, for example, the harvesting apparatus described in Japanese Patent Unexamined Publication No. S63-141517 is known.

FIG. 1 is a schematic configuration view of a harvesting apparatus disclosed in Japanese Patent Unexamined Publication No. S63-141517. The harvesting apparatus disclosed in Japanese Patent Unexamined Publication No. S63-141517 includes connecting pipe 94 connected to vacuum pad 95 for sucking fruits and connected to a vacuum suction device (not illustrated), and motor 93 for rotating and vibrating vacuum pad 95. In the harvesting apparatus, fruit 90 is sucked by vacuum pad 95, and vacuum pad 95 is rotated and vibrated to separate fruit 90 that becomes branch 92 from branch 92 at separation layer 91. In the harvesting apparatus disclosed in Japanese Patent Unexamined Publication No. S63-141517, a part of the surface of the fruit is vacuum-suctioned, and thus, damage such as a remaining suction mark on the fruit is caused.

### SUMMARY

According to an aspect of the disclosure, there is provided a harvesting method using a harvesting apparatus, the harvesting apparatus including: a pull-in mechanism for pulling a target among a plurality of targets that grow on a plant; and a harvesting mechanism for harvesting the target, the method comprising: a step of detecting a size and an inclination of the target; a step of adjusting an angle of the harvesting mechanism based on the inclination of the target; a step of adjusting a positional relationship between the harvesting mechanism and the pull-in mechanism based on the size of the target; a step of pulling the target in a direction of separating the target from a branch of the plant via the pull-in mechanism; a step of inserting the harvesting mechanism below the target pulled in the step of pulling; and a step of cutting the target from the plant by the harvesting mechanism inserted in the step of inserting.

### BRIEF DESCRIPTION OF THE DRAWINGS

FIG. 1 is a schematic configuration view of a harvesting apparatus disclosed in Japanese Patent Unexamined Publication No. S63-141517;

FIG. 2 is a perspective view illustrating an appearance of the harvesting apparatus according to an exemplary embodiment of the disclosure;

FIG. 3 is a perspective view illustrating an appearance of only a pull-in member illustrated in FIG. 2;

FIG. 4 is a perspective view illustrating a state of the harvesting apparatus in a case where a pull-in member driver illustrated in FIG. 2 is retracted most;

FIG. 5 is a perspective view illustrating an appearance of an upper harvesting ring illustrated in FIG. 2;

FIG. 6 is a perspective view illustrating an appearance of a lower harvesting ring illustrated in FIG. 2;

FIG. 7 is a perspective view illustrating the appearance of the harvesting apparatus illustrated in FIG. 2 when viewed from an opposite side;

FIG. 8 illustrates a cluster of fruits that are harvesting targets;

FIG. 9 is a flow chart illustrating an operating procedure of the harvesting apparatus for more reliably separating fruits at a separation layer;

FIG. 10 is a view for describing an operation of the harvesting apparatus;

FIG. 11 is a view for describing the operation of the harvesting apparatus;

FIG. 12 is a view for describing the operation of the harvesting apparatus;

FIG. 13 is a view for describing the operation of the harvesting apparatus;

FIG. 14 is a view for describing the operation of the harvesting apparatus;

FIG. 15 is a view for describing the operation of the harvesting apparatus;

FIG. 16 is a view for describing the operation of the harvesting apparatus;

FIG. 17 is a view for describing the operation of the harvesting apparatus;

FIG. 18 is a view for describing the operation of the harvesting apparatus;

FIG. 19 is a flow chart illustrating a procedure for realizing rotational vibration of a harvesting mechanism;

FIG. 20A is a view illustrating phases of vibration in an up-down direction and a front-back direction, which are components of the rotational vibration;

FIG. 20B is a view illustrating phases of the vibration in the up-down direction and the front back direction, which are components of the rotational vibration;

FIG. 20C is a view illustrating phases of the vibration in the up-down direction and the front-back direction, which are components of the rotational vibration;

FIG. 20D is a view illustrating phases of the vibration in the up-down direction and the front-back direction, which are components of the rotational vibration;

FIG. 21 is a rear perspective view illustrating the appearance of the harvesting apparatus according to the exemplary embodiment of the disclosure;

FIG. 22A is a view for describing the operation of the harvesting apparatus;

FIG. 22B is a view for describing the operation of the harvesting apparatus;

FIG. 23 is a flow chart illustrating an operating procedure of the harvesting apparatus including a step of detecting a fruit size and the like;

FIG. 24 is a view for describing the detection of the fruit size;

FIG. 25 is a view for describing the detection of the fruit inclination; and

FIG. 26 is a perspective view illustrating the appearance of a pull-in member according to a modification example.

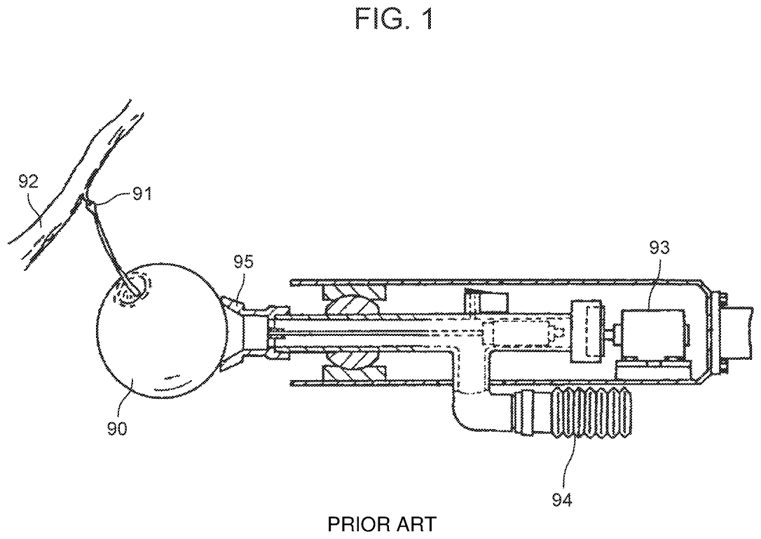

### DETAILED DESCRIPTION

Hereinafter, an exemplary embodiment of the present disclosure will be described in detail with reference to the drawings.

In the technique disclosed in Japanese Patent Unexamined Publication No. S63-141517, the pulling, twisting, bending and other forces exerted by the harvesting apparatus act not only on separation layer 91 but also on the entire range from fruit 90 to a supporter of branch 92. Therefore, in a case where fruit 90 has a calyx, similar to tomato, fruit 90 is not always separated at separation layer 91, and there is a possibility that fruit 90 is separated at the calyx. There is also a case where, in fruit 90 such as tomato from which the calyx is separated, the commercial value is reduced in terms of aesthetics of color and difficulty in confirming freshness. In a case where fruit 90 is difficult to be separated at separation layer 91, an unreasonable force acts on branch 92 or the like, causing damage to branch 92 or the like and the supporter thereof. There is a harvesting method for harvesting the target while suppressing the damage to fruit by a harvesting apparatus disclosed in Japanese Patent Unexamined Publication No. 2017-51103 and the like. However, in the harvesting method disclosed in Japanese Patent Unexamined Publication No. 2017-51103, while the harvesting is performed uniformly, the fruits have variations in size and fruit formation, and thus, the harvesting cannot be performed stably. An object of the disclosure is to provide a harvesting method for stably harvesting the target while suppressing the occurrence of damage. According to an aspect of the disclosure, there is provided a harvesting method using a harvesting apparatus including a pull-in mechanism for pulling one of a plurality of targets that grow on a plant and a harvesting mechanism for harvesting the pulled-in targets, the method including: a step of detecting a size and an inclination of the target; a step of adjusting an angle of the harvesting mechanism based on the inclination of the target; a step of adjusting a positional relationship between the harvesting mechanism and the pull-in mechanism based on the size of the target; a step of pulling the target in a direction of separating the target from a branch of the plant via the pull-in mechanism; a step of inserting the harvesting mechanism below the pulled-in target; and a step of cutting the target from the plant by the inserted harvesting mechanism. According to the harvesting method of the disclosure, it is possible to stably harvest the target while suppressing the occurrence of damage. Hereinafter, a harvesting apparatus capable of solving the above-described problems will be specifically described.

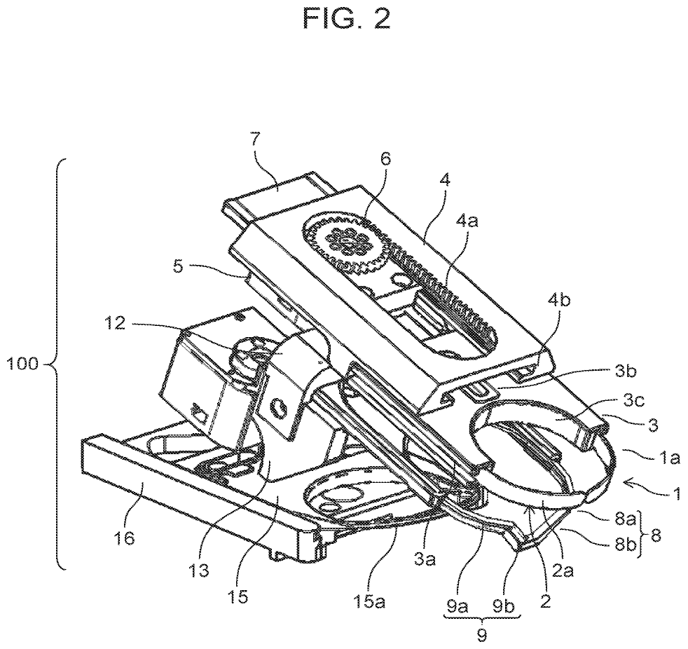

FIG. 2 is a perspective view illustrating an appearance of harvesting apparatus 100 according to the exemplary embodiment of the disclosure. In FIG. 2, harvesting apparatus 100 includes: a pull-in mechanism (that is, pull-in members 1, 2, and the like) for pulling fruits such as tomatoes in harvesting apparatus 100; a harvesting mechanism (upper harvesting ring 8, lower harvesting ring 9, and the like) for separating the fruits not at the calyx but at the separation layer; and a control device (not illustrated). The control device controls various operations of harvesting apparatus 100.

In the following description, the up-down direction is a direction parallel to gravity, the downward direction is a direction in which the gravity of the earth pulls fruits and the like, and the upward direction is a direction opposite to the downward direction. The front-back direction is a direction of approaching and being separated from the fruit when viewed from harvesting apparatus 100, the front direction is a direction in which harvesting apparatus 100 approaches the fruit, and the back direction is a direction in which harvesting apparatus 100 is separated from the fruit.

The harvesting target of harvesting apparatus 100 is a fruit or the like that has grown on a branch. More specifically, the harvesting target is a fruit having a fruit stalk and a separation layer. Examples of such fruits include strawberries, blueberries, raspberries and the like in addition to tomatoes.

In many cases, a plurality of these fruits are densely grown on branches. Here, harvesting apparatus 100 includes pull-in members 1 and 2 as mechanisms for attracting only specific fruits to harvesting apparatus 100 side in order to harvest only desired fruits.

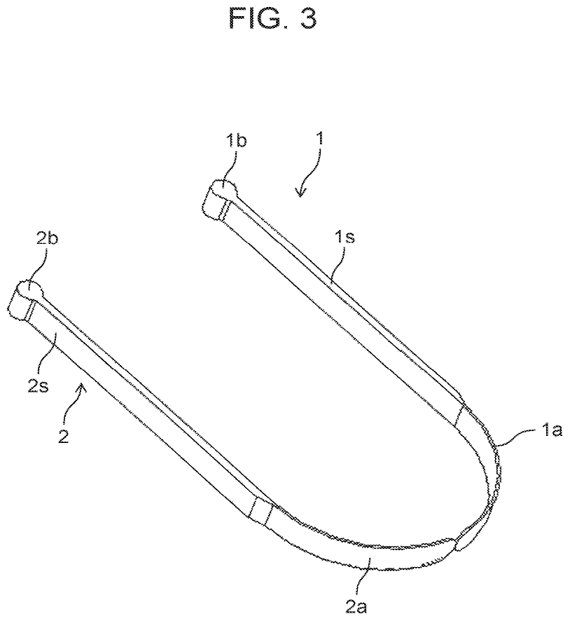

FIG. 3 is a perspective view illustrating the appearance of only pull-in members 1 and 2 illustrated in FIG. 2. Pull-in members 1 and 2 are elastic members. Pull-in members 1 and 2 include rectangular parallelepiped straight parts 1s and 2s, arcs 1a and 2a provided at one ends of straight parts 1s and 2s, and fixing ends 1b and 2b provided at the other ends of straight parts 1s and 2s, and are respectively have a J shape. Pull-in members 1 and 2 are paired and arranged in a U shape. As for pull-in members 1 and 2, only arcs 1a and 2a may be elastic members.

Refer to FIG. 2 again. Pull-in member holder 3 has a linear groove structure 3a on both sides. Groove structure 3a holds pull-in members 1 and 2 slidably, and elastically deforms arcs 1a and 2a of pull-in members 1 and 2 to store or makes pull-in members 1 and 2 projected.

Pull-in member driver 4 is a mechanism that holds fixing ends 1b and 2b of pull-in members 1 and 2 and drives pull-in members 1 and 2. Rack 4a is formed at a part of the center of pull-in member driver 4. Pull-in member driver 4 has recess 4b.

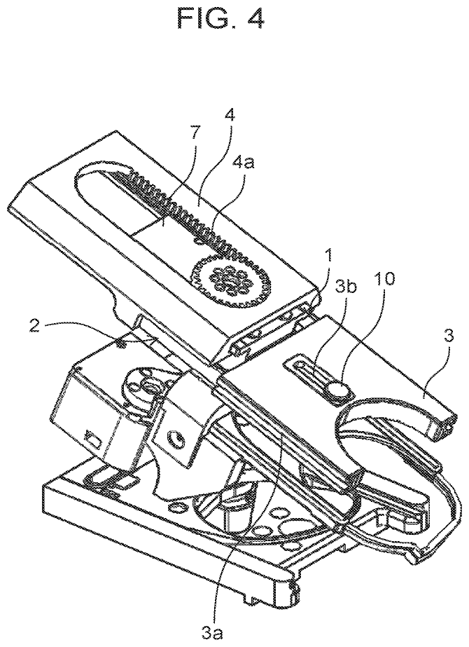

Driver guide 7 holds pull-in member driver 4 so as to move freely linearly via recess 4b of pull-in member driver 4. As illustrated in FIG. 4, pull-in member holder 3 is supported on the surface of driver guide 7 by pin 10 and can move linearly within the allowable range of pin groove 3b.

Pull-in motor 5 is mounted on driver guide 7. Pinion 6 is connected to the rotating shaft of pull-in motor 5, and pinion 6 is engaged with rack 4a. Here, when pull-in motor 5 rotates, pinion 6 rotates, and pull-in member driver 4 moves linearly with respect to driver guide 7. Pull-in member driver 4 is driven by these drive mechanisms, and accordingly, arcs 1a and 2a of the pair of pull-in members 1 and 2 can pull a desired fruit in a direction away from the branch.

As illustrated in FIG. 4, in a case where pull-in member driver 4 is retracted most, arcs 1a and 2a of pull-in members 1 and 2 are elastically deformed to become substantially flat and are stored in groove structure 3a. As illustrated in FIG. 2, in a case where pull-in member driver 4 moves forward most, arcs 1a and 2a of pull-in members 1 and 2 are elastically recovered in an arc shape in a free state, and the tip ends thereof approach each other.

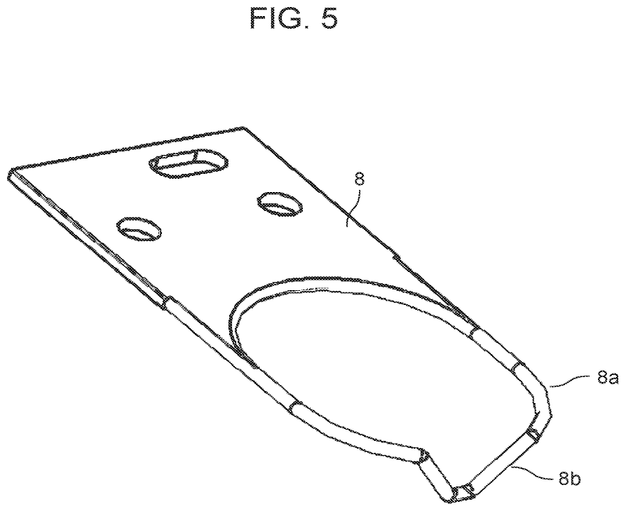

Upper harvesting ring 8 (refer to FIG. 5) and lower harvesting ring 9 (refer to FIG. 6) arranged vertically therebelow are mechanisms for harvesting desired fruits that have been pulled in by pull-in members 1 and 2.

Both upper harvesting ring 8 and lower harvesting ring 9 have arcs 8a and 9a (corresponding to ring part) formed in a substantially semicircular arc shape. Arcs 8a and 9a respectively house the fruits inside. Apart of arcs 8a and 9a forms V grooves 8b and 9b. V grooves 8b and 9b are recessed parts that are recessed downward, and V groove 8b fits into V groove 9b in a state where upper harvesting ring 8 overlaps the upper side of lower harvesting ring 9. As illustrated in FIG. 6, guide groove 9c is integrally formed in lower harvesting ring 9. Lower harvesting ring 9 holds upper harvesting ring 8 linearly and slidably along guide groove 9c.

Driver guide 7 and lower harvesting ring 9 are connected to each other by coupling member 12 such that the center axis that passes through the center of a circle of which a part is arc 8a of upper harvesting ring 8 perpendicularly to this circle, a center axis that passes through the center of the circle of which a part is arc 9a of lower harvesting ring 9 perpendicularly to this circle, and a center axis that passes through the center of the circle of which a part is arcuate recess 3c of pull-in member holder 3 perpendicularly to this circle are substantially parallel to each other.

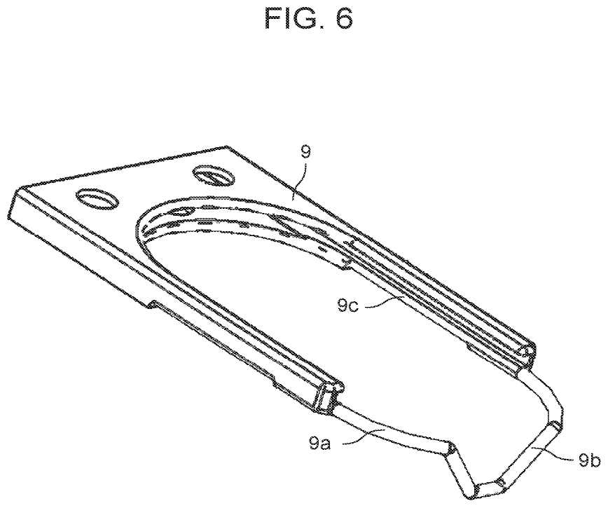

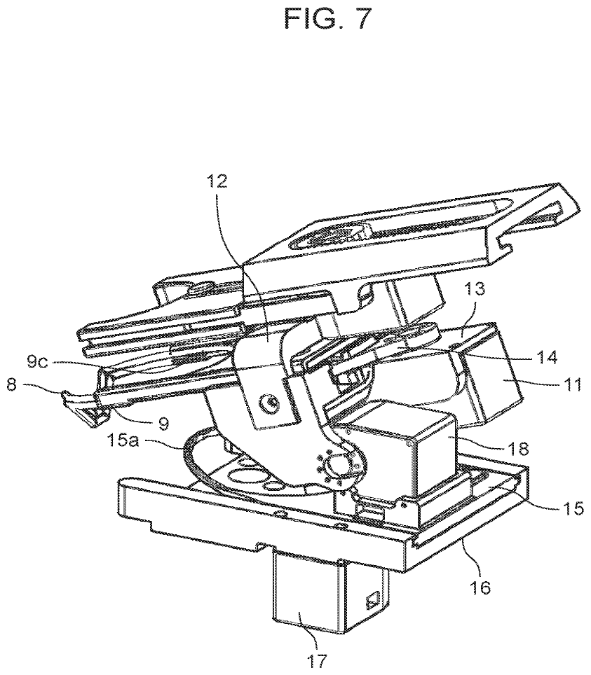

FIG. 7 is a perspective view illustrating the appearance of harvesting apparatus 100 of FIG. 2 when viewed from the opposite side. Disconnection motor 11 is fixed to lower harvesting ring 9 via motor holder 13. The rotating shaft of disconnection motor 11 is connected to upper harvesting ring 8 via arm 14. When disconnection motor 11 rotates, arm 14 drives upper harvesting ring 8 so as to move along guide groove 9c (refer to FIG. 6). In other words, disconnection motor 11 causes upper harvesting ring 8 and lower harvesting ring 9 to move relative to each other.

Base 16 holds slide base 15 so as to move freely linearly. Ring-shaped trap ring 15a is provided at the tip end of slide base 15.

In slide motor 17, the stator is fixed to base 16, and slide base 15 is driven with respect to base 16 by, for example, an arm (not illustrated). The stator of pitch motor 18 is fixed to slide base 15, and the rotor of pitch motor 18 is coupled to motor holder 13. Pitch motor 18 can drive motor holder 13 in the so-called pitching direction with respect to slide base 15, and drive the tip end of upper harvesting ring 8 or the like in the up-down direction relative to base 16. Accordingly, the distance between upper harvesting ring 8 and lower harvesting ring 9 and the desired fruit can be adjusted.

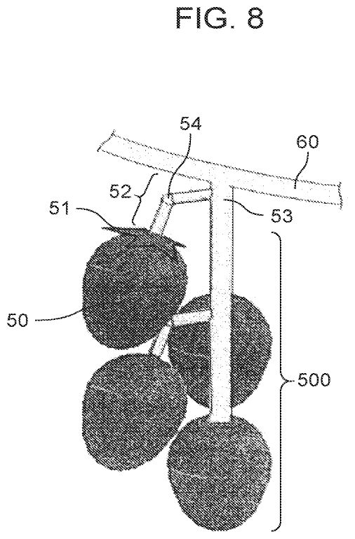

Here, a cluster of fruits, which is the harvesting target, is illustrated in FIG. 8. Here, tomato is illustrated as a fruit. In FIG. 8, some calyxes are not illustrated.

In cluster 500 branched from main stem 60, which is an example of a branch, a plurality of fruits grow around fruit stalk 53. Fruit 50 has calyx 51, and calyx 51 is connected to fruit stalk 53 via small fruit stalk 52. The upper part of fruit stalk 53 is further connected to main stem 60. Then, cluster 500 hangs down from main stem 60 due to the own weight or the like.

Separation layer 54 is a special cell layer formed between the branch and the axis of the fruit, and is a part which is positioned in the middle of small fruit stalk 52 and can be separated relatively easily by a pulling force or the like. In addition to separation layer 54, between fruit 50 and fruit stalk 53, there is a boundary between calyx 51 and fruit 50 as a part that can be easily separated. Therefore, in a case where fruit 50 is simply pulled, there is a case of being separated at separation layer 54 or a case of being separated at calyx 51.

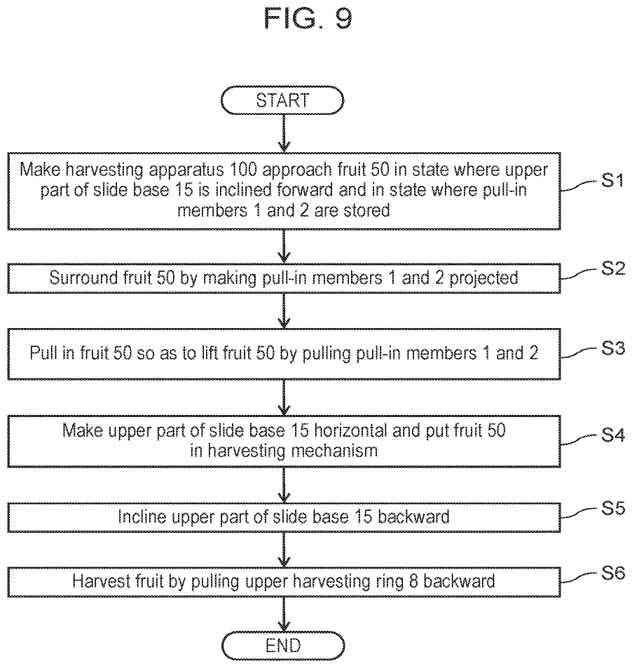

Next, the operation of harvesting apparatus 100 for more reliably separating fruit 50 at separation layer 54 will be described with reference to FIG. 9. FIGS. 10 to 18 are also views for describing the operation of harvesting apparatus 100, and the description thereof will be made as appropriate with reference to these views. The desired fruit is fruit 50.

First, harvesting apparatus 100 performs steps S1 to S3, which are processes for making it possible to harvest only fruit 50 from densely-grown fruit cluster 500, before the step of harvesting fruit 50.

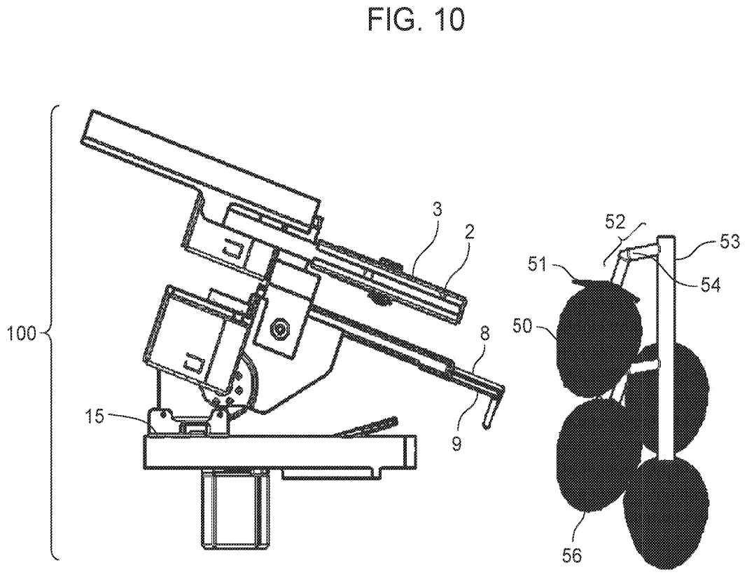

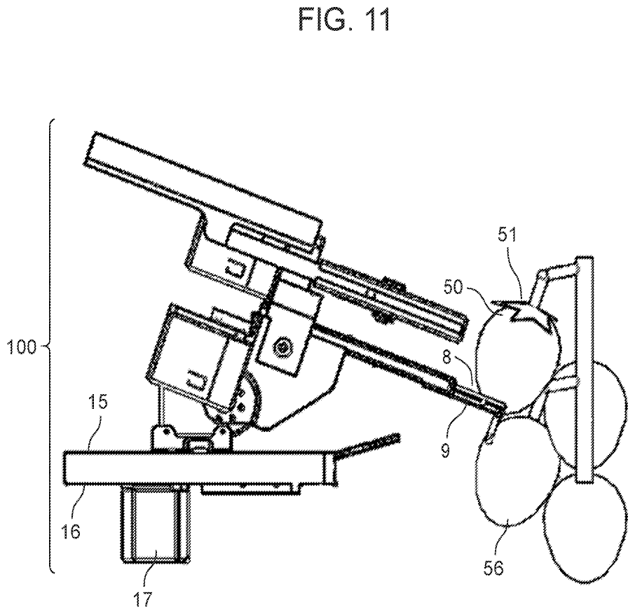

In step S1 of FIG. 9, as illustrated in FIG. 10, the harvesting mechanism (that is, upper harvesting ring 8 and lower harvesting ring 9) of harvesting apparatus 100 in a state where the upper part of slide base 15 is inclined forward, positions harvesting apparatus 100 so as to be between fruit 50 and fruit 56 therebelow. At this time, arcs 1a and 2a of pull-in members 1 and 2 illustrated in FIG. 2 and the like are stored in pull-in member holder 3. As illustrated in FIG. 11, the position of harvesting apparatus 100 is adjusted such that the harvesting mechanism is in a state of being sandwiched between fruit 50 and fruit 56 therebelow.

In step S2, harvesting apparatus 100 pushes pull-in member driver 4 toward the branch side of fruit 50 by driving pull-in motor 5 in a forward rotation, as illustrated in FIG. 12. Accordingly, harvesting apparatus 100 makes pull-in members 1 and 2 projected toward the branch side of fruit 50 such that arcs 1a and 2a surround fruit 50.

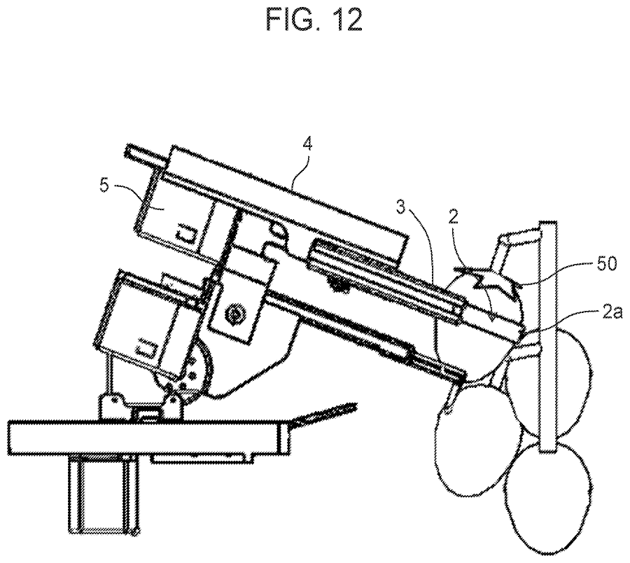

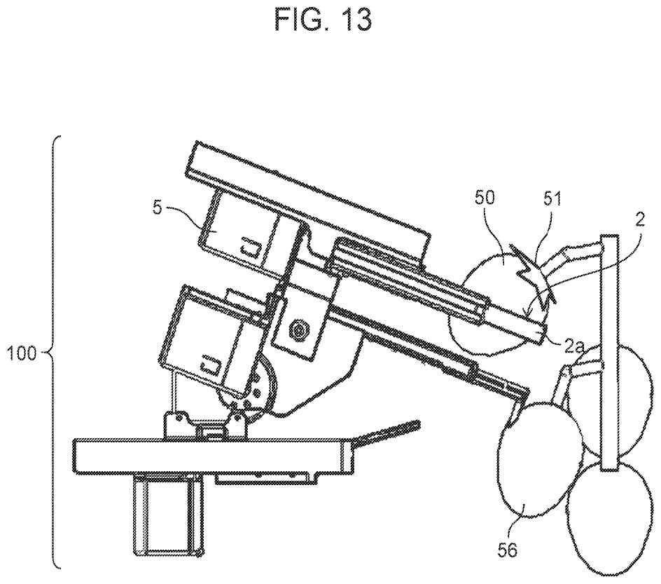

In step S3, harvesting apparatus 100 moves pull-in members 1 and 2 to the side away from the branch of fruit 50 by driving pull-in motor 5 in the reverse rotation, and pulls fruit 50 toward harvesting apparatus 100 side, as illustrated in FIG. 13. More specifically, harvesting apparatus 100 pulls the lower end of fruit 50 so as to lift the lower end diagonally upward. Accordingly, a gap is formed between desired fruit 50 and fruit 56 therebelow. In order to prevent calyx 51 from being separated from fruit 50 due to the pulling of pull-in members 1 and 2, the pull-in amount is set to, for example, approximately ¼ to ½ of the diameter of fruit 50. In the pair of pull-in members 1 and 2, the tip ends of pull-in members 1 and 2 are separated from each other as fruit 50 is pulled in. This is because, as described above, arcs 1a and 2a of pull-in members 1 and 2 are elastic members.

The above steps S1 to S3 are the contents of the pull-in step performed before harvesting only desired fruit 50 from the densely-grown fruit clusters.

Harvesting apparatus 100 performs the steps S4 to S6, which are the harvesting steps, after the pull-in step.

In step S4, as illustrated in FIG. 14, harvesting apparatus 100 drives pitch motor 18 in a reverse rotation to make the upper part of slide base 15 inclined forward horizontal, and accordingly, upper harvesting ring 8 and lower harvesting ring 9, which are the harvesting mechanisms, are inserted between fruit stalk 53 and fruit 50. At this time, as arcs 1a and 2a rise, there is a possibility that arcs 1a and 2a come into contact with small fruit stalk 52 or fruit stalk 53 of fruit 50, but arcs 1a and 2a are elastic members and are easily deformed, and thus, arcs 1a and 2a do not damage small fruit stalk 52 or fruit stalk 53.

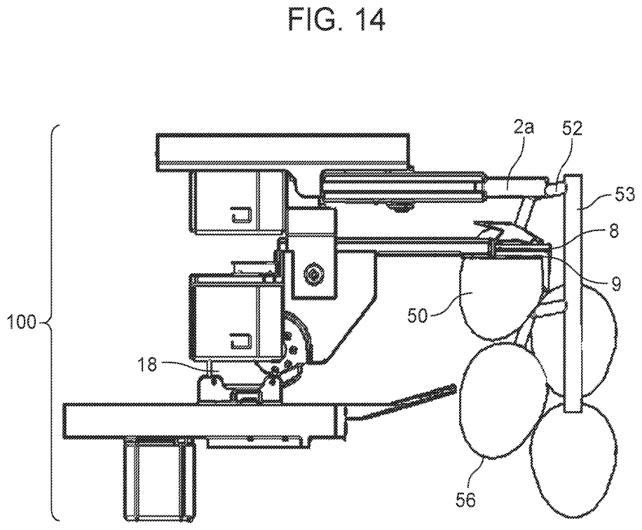

In step S5, harvesting apparatus 100 further reversely rotates pitch motor 18 from the state of FIG. 14, and as illustrated in FIG. 15, inclines the upper part of slide base 15 backward such that the longitudinal direction of upper harvesting ring 8 and the longitudinal direction of lower harvesting ring 9 and the center line passing through the upper end and the lower end of fruit 50 are made substantially parallel to each other. Accordingly, the harvesting mechanism reaches small fruit stalk 52 of fruit 50, and as a result, as illustrated in FIG. 16, V grooves 8b and 9b are inserted between fruit stalk 53 and calyx 51.

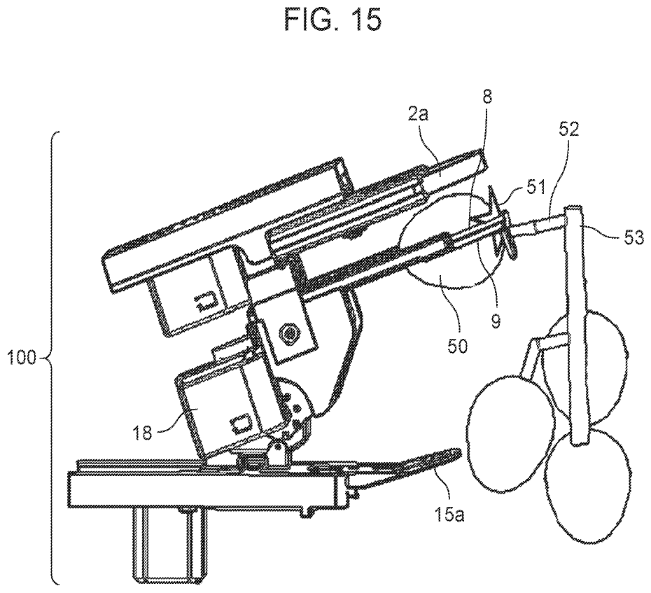

In step S6, when harvesting apparatus 100 drives disconnection motor 11, upper harvesting ring 8 is pulled by arm 14 along guide groove 9c (refer to FIG. 6) as illustrated in FIG. 17. As a result, upper harvesting ring 8 is pulled in the direction (backward) in which fruit 50 including calyx 51 is separated from fruit stalk 53. As fruit 50 is pulled, fruit stalk 53 is also attracted via small fruit stalk 52, but fruit stalk 53 and lower harvesting ring 9 come into contact with each other, and a force of pushing fruit stalk 53 to lower harvesting ring 9 is generated as a reaction of the pulling force of upper harvesting ring 8. At this time, since V groove 8b comes into contact with calyx 51 of fruit 50, the pulling force for pulling calyx 51 and fruit stalk 53 apart acts between calyx 51 and fruit stalk 53, and as illustrated in FIGS. 17 and 18, small fruit stalk 52 is separated at separation layer 54. At this time, since the pulling force for pulling fruit 50 and calyx 51 apart does not act between fruit 50 and calyx 51, calyx 51 is not separated from fruit 50. Since harvesting apparatus 100 can prevent direct contact with fruit 50 during the harvesting step, it is possible to prevent fruit 50 from being damaged.

Upper harvesting ring 8 and lower harvesting ring 9 are arranged so as to overlap each other, and in particular, V grooves 8b and 9b are arranged so as to fit each other. Accordingly, in the separation step of step S6, the rotational moment that acts on fruit 50 can be reduced with respect to fruit stalk 53, and fruit 50 can be prevented from detaching from lower harvesting ring 9 due to rotation. In addition, the pulling force can be efficiently applied to separation layer 54, and separation is hardly made at a place other than separation layer 54.

When the gap between upper harvesting ring 8 and lower harvesting ring 9 including the gap of V grooves 8b and 9b is extremely small, there is also a possibility of sandwiching calyxes or the like of other fruits, and thus, for example, the gap is set to be approximately 0.3 mm or more and 1 mm or less.

The above steps S4 to S6 are the contents of the harvesting step.

After this, harvested fruit 50 with calyx 51 falls and passes through trap ring 15a of FIG. 2. In a case where harvesting apparatus 100 functions as a harvesting system, it is desirable to arrange a container or the like for collecting harvested fruits 50 under trap ring 15a.

In the exemplary embodiment, lower harvesting ring 9 is fixed and upper harvesting ring 8 is moved. However, the disclosure is not limited thereto. In other words, upper harvesting ring 8 and lower harvesting ring 9 may be relatively moved, and for example, upper harvesting ring 8 may be fixed and lower harvesting ring 9 may be moved, or both upper harvesting ring 8 and lower harvesting ring 9 may be moved. With such a configuration, as illustrated in FIG. 17, even in a case where another fruit 56 comes into contact with trap ring 15a, upper harvesting ring 8 and lower harvesting ring 9 can be projected to the right (branch direction) of the paper in FIG. 17. As a result, upper harvesting ring 8 and lower harvesting ring 9 can be easily inserted into fruit 50, and when upper harvesting ring 8 is attracted to the left (opposite to the branch) of the paper in FIG. 17 relative to lower harvesting ring 9, fruit 50 can be passed through trap ring 15a.

Due to the configuration of upper harvesting ring 8 and lower harvesting ring 9, a pulling force acts on separation layer 54 more reliably, and it is unlikely that the commercial value deteriorates, such as the calyx 51 being removed or damage occurring.

In a case where the diameter of fruit 50, which is the target, is relatively large, a sufficient pulling force can be applied without providing V grooves 8b and 9b. However, in order to more reliably separate fruit 50 around separation layer 54, it is desirable that V grooves 8b and 9b are formed.

In harvesting apparatus 100 according to the exemplary embodiment, slide motor 17, pitch motor 18, and the like are provided to set the posture or the position with respect to the fruit, but an appropriate manipulator arm may realize these functions.

In the exemplary embodiment, an example in which the target, which is fruit 50, grows on a branch is illustrated, but the harvesting may be performed by setting fruit that grows on a plant as a target. In this case, the drive mechanism may move lower harvesting ring 9 toward the plant on which the target grows, or upper harvesting ring 8 away from the plant on which the target grows.

Here, in the harvesting method of the above-described exemplary embodiment, when upper harvesting ring 8 and lower harvesting ring 9 are inserted between the fruits in a dense state, resistance such as friction may become a problem. Therefore, here, a method of vibrating upper harvesting ring 8 and lower harvesting ring 9 to change the frictional force between fruits 50 into a dynamic friction state and to facilitate the insertion, and a method of reducing the normal force, will be described.

In this case, as a specific method of setting the dynamic friction state, an eccentric motor for vibration or the like is installed at a part of lower harvesting ring 9. By matching the rotation frequency of the eccentric motor with the primary resonance frequency of the mechanical vibration system of harvesting apparatus 100, the amplitude can be efficiently obtained. Depending on the installation method of the eccentric motor, vibration directions such as the up-down direction and the front-back direction can be obtained.

Harvesting apparatus 100 including the eccentric motor uses pull-in members 1 and 2 to pull one of the plurality of fruits that grow on a branch as a desired fruit in a direction of being separated from the branch, and inserts the harvesting mechanism (that is, upper harvesting ring 8 and lower harvesting ring 9) below the pulled-in fruit. At this time, harvesting apparatus 100 solves the problem of friction by inserting the harvesting mechanism while vibrating the harvesting mechanism, and can properly harvest only desired fruit.

Harvesting apparatus 100 can smoothly insert the harvesting mechanism below the desired fruit while pushing up only the desired fruit by putting the vibration into a compound wave state. Therefore, harvesting apparatus 100 introduces rotational vibration that combines vibrations in the up-down direction and the front-back direction. This rotational vibration has the same vibration frequency in the up-down direction and the front-back direction of the vibration, and is 90 degrees out of phase.

In harvesting apparatus 100, the step of vibrating the harvesting mechanism includes a first step of displacing the tip end of the harvesting mechanism downward and at the same time displacing the tip end of the harvesting mechanism in the direction (that is, in the direction opposite to the direction of being separated from the branch) closer to the branch. In harvesting apparatus 100, the step of vibrating the harvesting mechanism includes a second step of displacing the tip end of the harvesting mechanism upward and at the same time displacing the tip end of the harvesting mechanism in the direction of being separated from the branch. In the first step, harvesting apparatus 100 inserts the harvesting mechanism below the desired fruit, and in the second step, the desired fruit is pulled in in the direction of being separated from the branch.

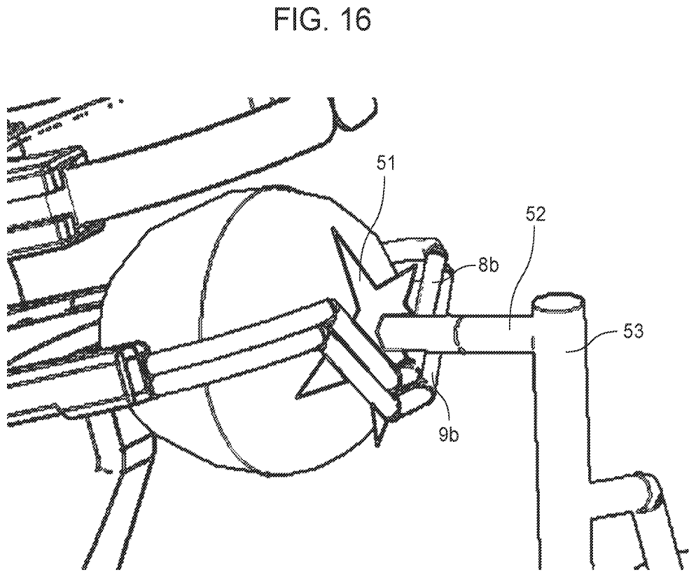

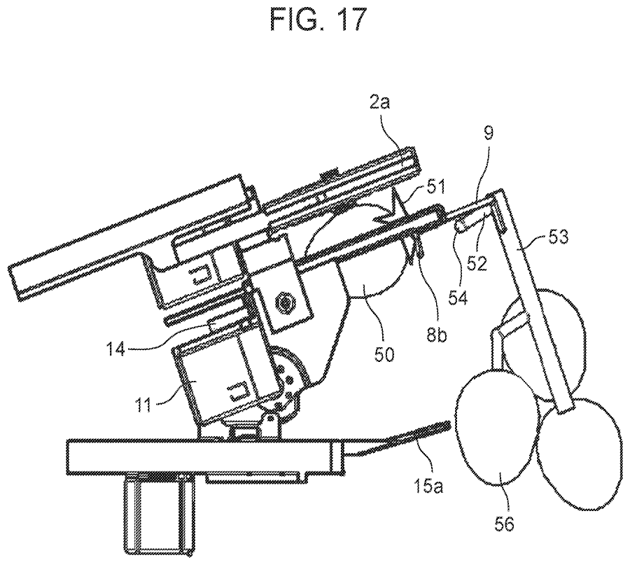

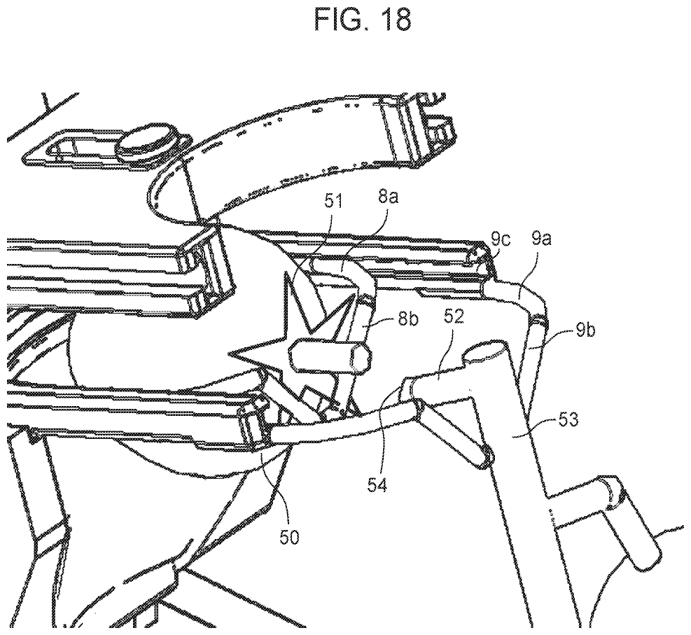

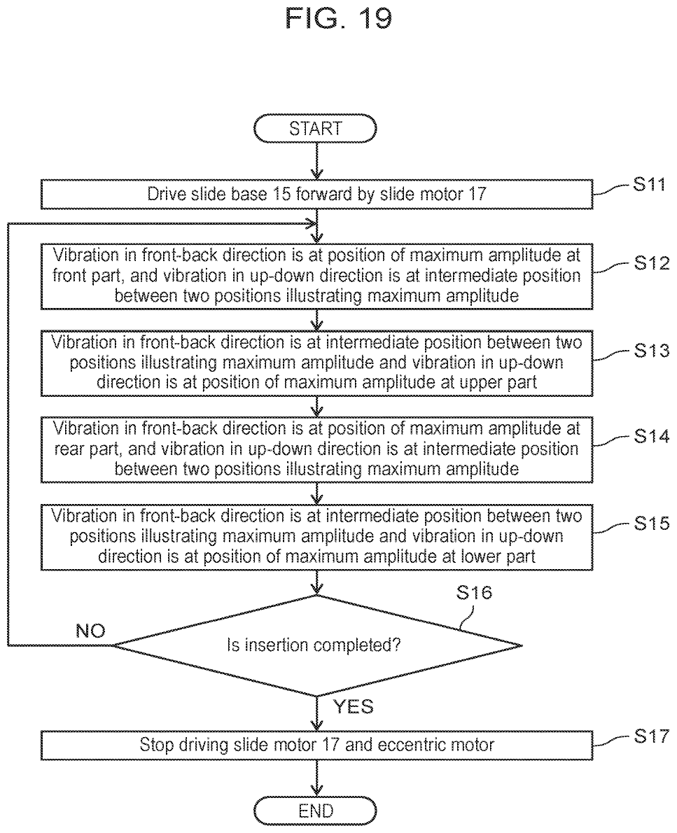

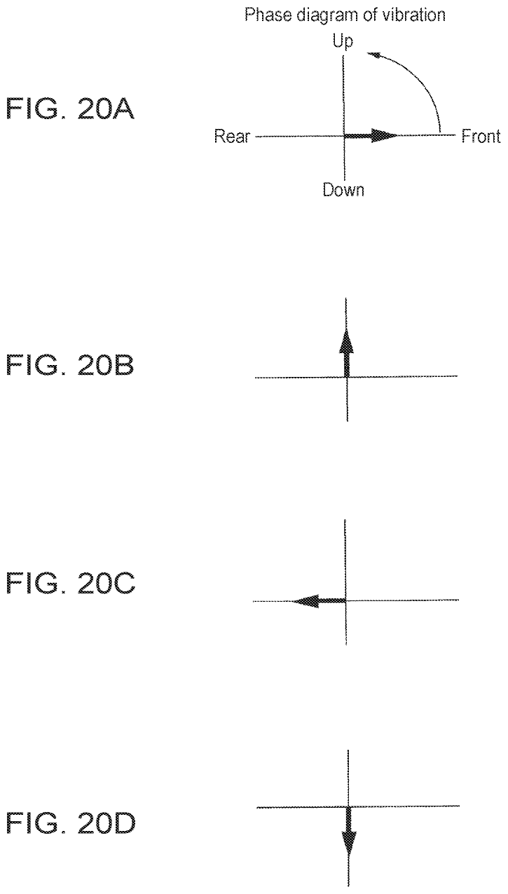

FIG. 19 is a flow chart illustrating a procedure for realizing the rotational vibration of the harvesting mechanism. FIGS. 20A to 20D are views illustrating phases of vibration in the up-down direction and the front-back direction, which are components of the rotational vibration. The thick arrows in the phase diagrams of FIGS. 20A to 20D indicate the moving direction of the tip end of upper harvesting ring 8. Hereinafter, the procedure for realizing the rotational vibration of the harvesting mechanism will be described in detail with reference to FIGS. 19 and 20A to 20D. As an initial state before the rotational vibration is performed, the positional relationship between the harvesting mechanism of harvesting apparatus 100 and fruit 50 is set to the state illustrated in FIG. 11, and the vibration is started from this state. In step S11, harvesting apparatus 100 drives slide base 15 forward by slide motor 17.

In step S12, regarding the vibration of the tip end of the harvesting mechanism in the front-back direction, harvesting apparatus 100 drives the eccentric motor such that the position of the tip end of the harvesting mechanism is the position of the maximum amplitude at the front, and makes the tip end of the harvesting mechanism start the rotational vibration. At this time, regarding the vibration in the up-down direction, the position of the tip end of the harvesting mechanism is an intermediate position between the two positions illustrating the maximum amplitude in the up-down direction.

In steps S12 to S13, harvesting apparatus 100 displaces upward while pulling the tip end of the harvesting mechanism backward, as illustrated in FIGS. 20A to 20B. Accordingly, the harvesting mechanism pushes up fruit 50, the frictional force between the harvesting mechanism and fruit 50 increases, and fruit 50 is pulled later.

In step S13, regarding the vibration of the tip end of the harvesting mechanism in the front-back direction, the position of the tip end of the harvesting mechanism is an intermediate position between the two positions illustrating the maximum amplitude in the front-back direction, and regarding the vibration in the up-down direction, the position of the tip end of the harvesting mechanism is the position of the maximum amplitude at the upper part. Therefore, the frictional force is maximized, and fruit 50 can be pulled in toward the apparatus with a stronger force.

In step S14, regarding the vibration of the tip end of the harvesting mechanism in the front-back direction, the rotation is made such that the position of the tip end of the harvesting mechanism is the position of the maximum amplitude at the rear part, and regarding the vibration of the tip end of the harvesting mechanism in the up-down direction, the rotation is made such that the position of the tip end of the harvesting mechanism is the intermediate position between the two positions illustrating the maximum amplitude in the up-down direction. Accordingly, fruit 50 is further attracted toward the apparatus.

In steps S14 to S15, harvesting apparatus 100 displaces downward while moving the tip end of the harvesting mechanism forward, as illustrated in FIGS. 20C to 20D. Accordingly, the harvesting mechanism is displaced so as to be separated downward from fruit 50, and the frictional force between the harvesting mechanism and fruit 50 is reduced. At the same time, the harvesting mechanism moves forward with respect to fruit 50, and thus, slides and displaces relatively forward. In other words, the harvesting mechanism is inserted below fruit 50 by the amount related to the amplitude of vibration while reducing the frictional force.

In step S15, regarding the vibration of the tip end of the harvesting mechanism in the front-back direction, the position of the tip end of the harvesting mechanism is the intermediate position between the two positions illustrating the maximum amplitude in the front-back direction, and regarding the vibration of the tip end of the harvesting mechanism in the up-down direction, the position of the tip end of the harvesting mechanism is the position of the maximum amplitude at the lower part. Accordingly, it becomes easy to insert the harvesting mechanism below fruit 50.

In this manner, steps S12 to S15 are repeated until the insertion of the harvesting mechanism is completed (step S16: NO).

When the insertion of the harvesting mechanism is completed (step S16: YES), in step S17, harvesting apparatus 100 stops driving slide motor 17 and the eccentric motor.

Since slide motor 17 drives slide base 15 forward at the same time as the vibration, fruit 50 is pulled later in a case where the frictional force is large, and the harvesting mechanism is inserted between fruit 50 and another fruit 56 in a case where the frictional force is small.

It has already been described that efficiency is high when the frequency of the vibration by the eccentric motor matches the mechanical vibration system, but in a case where harvesting apparatus 100 has the front-back direction as the longitudinal direction as illustrated in FIG. 2, the vibration frequency in the direction orthogonal to the longitudinal direction is likely to decrease. In other words, since the vibration frequency in the up-down direction is relatively low with respect to the front-back direction and the amplitude is large, the vibration in the up-down direction is likely to occur, and fruit 50 is easily pulled in.

In this manner, the vibration frequency in the front-back direction and the vibration frequency in the up down direction generally do not match each other, and thus, in a case of being driven by one motor, the locus of the tip end of the thick arrow in the phase diagram of FIGS. 20A to 20D becomes elliptical. Meanwhile, in a case where the phase diagram is close to a perfect circle, fruit 50 is more likely to be pulled in. In order to bring it closer to a perfect circle, it is effective to make the resonance frequency in the front-back direction and the resonance frequency in the up-down direction match each other. Specifically, by connecting a spring that vibrates in the front-back direction to the back of the eccentric motor, the resonance frequency in the front-back direction and the resonance frequency in the up-down direction can match each other.

The vibration may be realized by one motor. It is also possible to use two motors to generate vibrations of which the resonance frequencies match each other in each direction, and in this case, it is possible to obtain larger vibrations for each frequency.

In the above-described method, the means for harvesting one of the plurality of targets that grow on plants has been disclosed, but in this case, since the harvesting is performed uniformly, the harvesting for fruits having different sizes and inclinations is not stably performed.

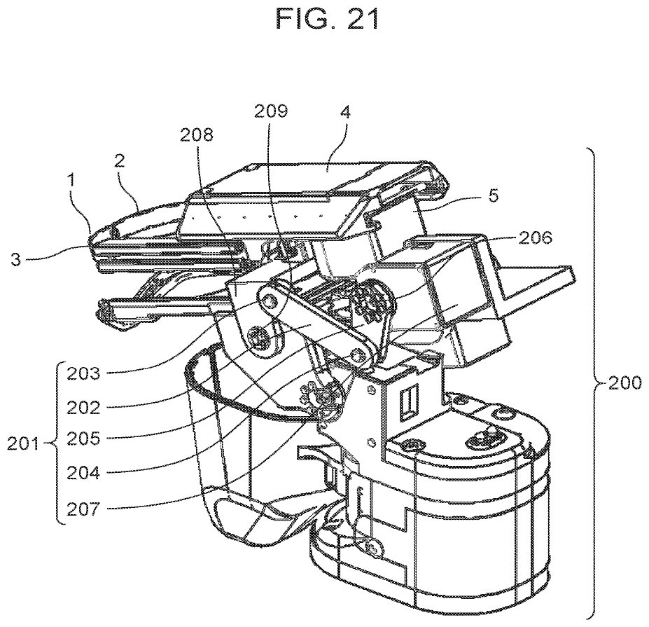

Before starting the harvesting operation of FIG. 9, based on the step of detecting the size and inclination of the target, the step of adjusting the angle formed by the harvesting mechanism with respect to the inclination of the target, and the size of the target, by performing the step of adjusting the positional relationship between the harvesting mechanism and the pull-in mechanism, more stable harvesting can be performed. The harvesting apparatus for performing such a process will be described. FIG. 21 is a rear perspective view illustrating the appearance of harvesting apparatus 200.

In addition to the same configuration as that of harvesting apparatus 100 described above, harvesting apparatus 200 includes an image acquisition device and an image processing device (not illustrated respectively) for detecting the size and inclination of the target. The image acquisition device acquires an image of the target viewed from one side of harvesting apparatus 200 in the left-right direction (directions orthogonal to the up-down direction and the front-back direction).

Harvesting apparatus 200 includes driver 201 such that the angle of the pull-in mechanism including pull-in members 1 and 2, pull-in member holder 3, pull-in member driver 4, pull-in motor 5, and the like can be changed with respect to the vertical direction. Driver 201 includes link bar 202. Link shaft 203 and link shaft 204 are inserted on both ends of link bar 202, respectively. One link shaft 204 is inserted through link drive lever 205. Link drive lever 205 receives power from drive actuator 207 via drive shaft 206.

Another link shaft 203 is fixed to pull-in member attacher 208. With such a configuration, the above-described pull-in mechanism is interlocked with pull-in member attacher 208 that rotates with respect to swing shaft 209. By utilizing this movement, the relative positional relationship between the pull-in mechanism including pull-in members 1 and 2 and the harvesting mechanism including harvesting rings 8 and 9 can be adjusted.

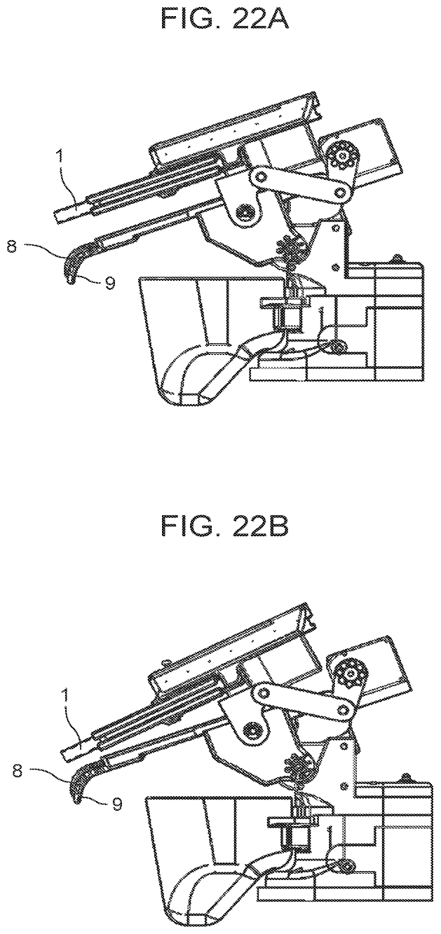

FIG. 22A illustrates a state where drive actuator 207 of driver 201 is controlled so as to keep the pull-in mechanism and the harvesting mechanism parallel to each other. On the other hand, FIG. 22B illustrates a state where the relative distance between the pull-in mechanism and the harvesting mechanism is shortened by rotating drive actuator 207 of driver 201 and rotating the pull-in mechanism with respect to the harvesting mechanism. On the contrary, it is also possible to increase the relative distance between the pull-in mechanism and the harvesting mechanism.

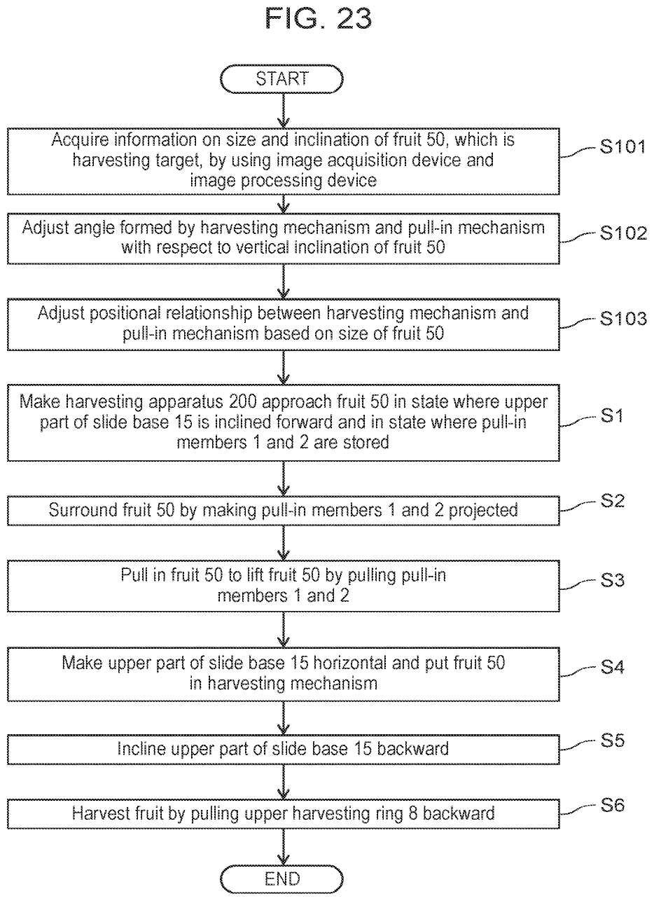

Next, the harvesting method using harvesting apparatus 200 described above will be described in detail with reference to FIG. 23. FIG. 23 is a flow chart illustrating an operating procedure of the harvesting apparatus including a step of detecting the fruit size and the like.

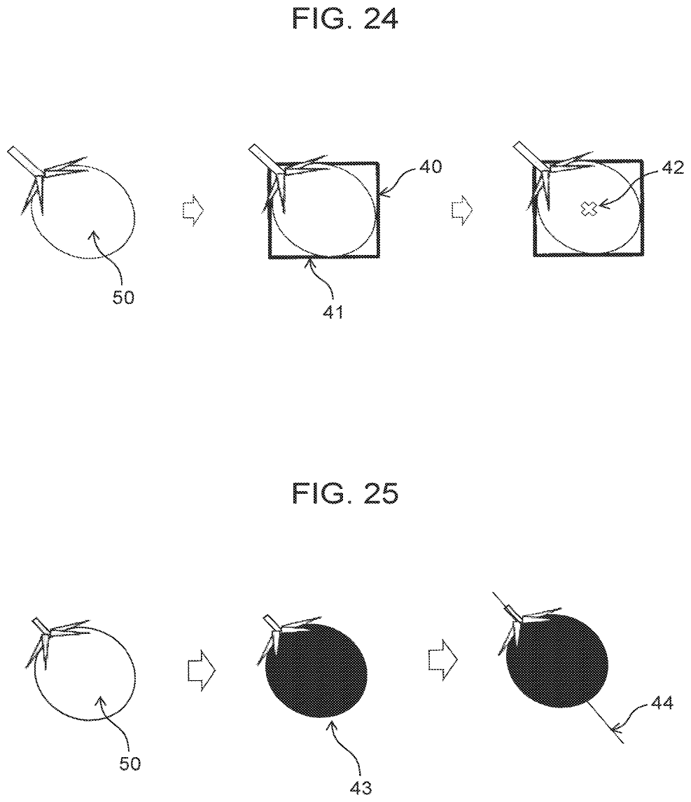

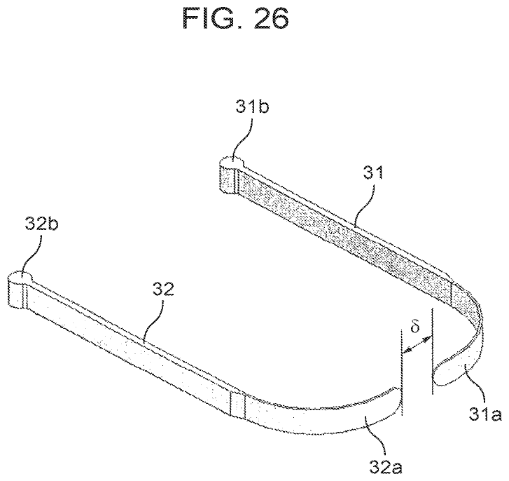

First, in step S101 of FIG. 23, harvesting apparatus 200 acquires information on the size and inclination of fruit 50, which is an example of the target to be harvested, by using the image acquisition device and the image processing device. In addition to fruits, vegetables can be exemplified as the target. Here, a method for detecting the size and inclination of fruit 50 will be described with reference to FIGS. 24 and 25.

FIG. 24 illustrates an example of a method for detecting the size of fruit 50. The image processing device generates rectangle 40 so as to surround the existing region of fruit 50 in the image of fruit 50 acquired by the image acquisition device. In the exemplary embodiment, rectangle 40 has left and right sides parallel to the gravity direction (vertical direction) and upper and lower sides parallel to the horizontal direction orthogonal to the vertical direction, but the disclosure is not limited to such a configuration. The center portion of the lower side of rectangle 40 is regarded as lower end 41 (hereinafter, there is a case of being referred to as “target lower end 41”) of fruit 50. The intersection of the diagonal lines of rectangle 40 is regarded as pseudo center 42 (hereinafter, there is a case of being referred to as “target center 42”) of fruit 50. In this manner, the image processing device acquires information related to the size of the fruit 50.

FIG. 25 illustrates an example of a method for detecting the inclination of fruit 50. The image processing device extracts the existing region of fruit 50 from the image of fruit 50 acquired by the image acquisition device, and then obtains binary image 43 corresponding to the fruit part based on the color information of fruit 50. Subsequently, the inclination of main axis 44 of binary image 43 described above is calculated, and the calculated inclination is used as the inclination (how the fruit grows) of fruit 50 with respect to the vertical direction. At this time, in binary image 43, a line connecting the boundary position between the fruit part and the calyx part and the position corresponding to center 42 of fruit 50 is set on main axis 44. According to this, it is possible to acquire information on the inclination (vertical inclination) of fruit 50 with respect to the vertical direction.

The description returns to FIG. 23. Next, in step S102, the angle formed by the harvesting mechanism and the pull-in mechanism with respect to the vertical inclination of fruit 50 acquired in the above-described step S101 is adjusted to an angle suitable for harvesting.

Specifically, the angles of the harvesting mechanism and the pull-in mechanism are adjusted such that the upper part of the harvesting mechanism is inserted perpendicularly with respect to the vertical inclination of fruit 50 acquired in step S101. According to this, it is likely to insert fruit 50 into the harvesting mechanism. In other words, even when the fruit grows unevenly, harvesting is possible at an angle suitable for each individual, and stable harvesting can be performed. Such adjustment of the angles of the harvesting mechanism and the pull-in mechanism can be performed by driving pitch motor 18 of FIG. 7 as described in the harvesting operation. In the exemplary embodiment, the angles of both the harvesting mechanism and the pull-in mechanism are adjusted in the same manner, but the angle of only the harvesting mechanism may be adjusted and the angle of the pull-in mechanism may not be adjusted.

Ideally, the angle of the harvesting mechanism suitable for harvesting is preferably 90° (that is, perpendicular to) with respect to the vertical inclination of fruit 50 obtained in step S101. However, harvesting is possible even when the inclination is not 90°, and stable harvesting is possible by controlling harvesting apparatus 200 such that the harvesting mechanism is 45° or more and 135° or less with respect to the vertical inclination of fruit 50. In the exemplary embodiment, a state where the harvesting mechanism is 90° or 45° or more and 135° or less with respect to the vertical inclination of fruit 50 means a state where the angle formed by the vertical inclination of fruit 50 and the direction in which harvesting rings 8 and 9 extend is 90° or 45° or more and 135° or less when viewed from one side in left-right direction.

Next, in step S103, harvesting apparatus 200 adjusts the positional relationship (relative distance) between the harvesting mechanism and the pull-in mechanism to a positional relationship suitable for harvesting, based on the size of fruit 50 acquired in the above-described step S101.

Specifically, based on target lower end 41 and target center 42, which are information related to the size of fruit 50 acquired in the above-described step S101, for example, as illustrated in FIG. 22B, by rotating the pull-in mechanism with respect to the harvesting mechanism and adjusting the angle formed by the harvesting mechanism and the pull-in mechanism, the positional relationship between the harvesting mechanism and the pull-in mechanism is adjusted. At this time, the harvesting mechanism is inserted at a height that is several millimeters to several tens of millimeters lower in the vertical downward direction with respect to target lower end 41, and the positional relationship is adjusted such that the pull-in mechanism pulls the vicinity of target center 42.

In the exemplary embodiment, a mechanism for rotating the pull-in mechanism is used as a mechanism for adjusting the positional relationship between the harvesting mechanism and the pull-in mechanism, but for example, a mechanism for moving the pull-in mechanism up and down may be used while maintaining a state where the pull-in mechanism is parallel to the harvesting mechanism.

By utilizing this mechanism, in the next step S1, harvesting rings 8 and 9 can be inserted at a height of several millimeters to several tens of millimeters lower in the vertical downward direction from lower end 41 of fruit 50, and the pull-in mechanism can be inserted at a vertical height of the target center 42, respectively. According to this, even when the targets to be harvested vary in size, fruit 50 can be pulled in more stably. In other words, even when the actual size varies, the pull-in mechanism and the harvesting mechanism can be inserted at positions suitable for each, and stable harvesting can be performed.

When harvesting rings 8 and 9 are inserted below fruit 50, the processes of steps S11 to S17 as illustrated in FIG. 19 may be performed. In this manner, harvesting rings 8 and 9 can be easily inserted between the targets in a dense state.

After this, the above-described processes of steps S2 to S6 are performed. In this manner, targets of various sizes and angles can be continuously and stably harvested.

### Modification Example

Here, a modification example of the pull-in member will be described.

FIG. 26 is a perspective view illustrating the appearance of pull-in members 31 and 32 according to a modification example. In the free state of arcs 31a and 32a (at the start of pulling), gap 8 is provided at the tip ends of arcs 31a and 32a. By providing gap 8, there is an effect that the pulling-in of only fruit 50 becomes much easier while avoiding small fruit stalk 52 and fruit stalk 53 in FIGS. 14 to 17. The minimum value of this gap 8 is larger than the dimension of the fruit stalk, and the maximum value is smaller than the size of the fruit which is the target. Taking a cluster of tomatoes as an example, gap 8 is approximately 5 to 10 mm.

A harvesting system can also be constructed by mounting harvesting apparatus 100 on the manipulator arm installed on a moving carriage. With this system, the moving carriage can move in the farm and automatically harvest the target.

In each of the exemplary embodiments, upper harvesting ring 8 and lower harvesting ring 9 have been described as rings having substantially semicircular arcs 8a and 9a, but the disclosure is not limited thereto. For example, the arcs of upper harvesting ring 8 and lower harvesting ring 9 may not form a part of a circle, but may form a part of an ellipse or a part of a polygon.

The harvesting method of the disclosure can be applied to harvest various fruits and the like.

What is claimed is:

1. A harvesting method using a harvesting apparatus, the harvesting apparatus including a harvesting mechanism for harvesting a harvesting target that grows on a plant, the method comprising:
determining a vertical inclination, which is an inclination with respect to a vertical direction, of the harvesting target from an acquired image of the harvesting target;
adjusting an angle of the harvesting mechanism with respect to the vertical inclination;
bringing the harvesting mechanism closer to the harvesting target; and
separating the harvesting target from the plant by the harvesting mechanism.

2. The harvesting method of claim 1, wherein
in the adjusting, the angle of the harvesting mechanism with respect to the vertical inclination is adjusted to 45° or more and 135° or less.

3. The harvesting method of claim 2, wherein
in the adjusting, the angle of the harvesting mechanism with respect to the vertical inclination is adjusted to 90°, and
in the bringing the harvesting mechanism closer to the harvesting target, the harvesting mechanism is inserted in the harvesting target perpendicularly with respect to the vertical inclination.

4. The harvesting method of claim 1, wherein
the harvesting target is a tomato.

5. The harvesting method of claim 4, wherein
in the separating, a pulling force is applied between a calyx and a fruit stalk of the tomato.

6. The harvesting method of claim 1, wherein
in the bringing the harvesting mechanism closer to the harvesting target, the harvesting mechanism is brought closer to the harvesting target based on information on the harvesting target determined from the acquired image of the harvesting target.

7. The harvesting method of claim 1, wherein
in the adjusting, the angle of the harvesting mechanism is adjusted based on information on the harvesting target determined from the acquired image of the harvesting target.

8. The harvesting method of claim 6, wherein
a size of the harvesting target is recognized by image recognition.

9. The harvesting method of claim 7, wherein
a size of the harvesting target is recognized by image recognition.
